(19) United States
(12) Patent Application Publication
(10) Pub. No.: US 2016/0159484 A1
(43) Pub. Date: Jun. 9, 2016

(54) PORTABLE MOUNTING SYSTEM

(71) Applicants: Charles Alan Sharp, Sykesville, MD (US); Gregory Wayne Jordan, Glenwood, MD (US)

(72) Inventors: Charles Alan Sharp, Sykesville, MD (US); Gregory Wayne Jordan, Glenwood, MD (US)

(73) Assignee: SKYCOMP, INC., Columbia, MD (US)

(21) Appl. No.: 14/561,911

(22) Filed: Dec. 5, 2014

(51) Int. Cl. B64D 11/06

(52) U.S. Cl. CPC B64D 11/0627; B64D 11/062

(57) ABSTRACT

A mounting system includes an elongated member having a first end and a second end; at least one mount assembly operatively connected to the first end of the elongated member, wherein the at least one mount assembly includes a mount and a securing channel attached to the mount; a plate operatively connected to the second end of the elongated member; a flange attached to the plate; and a bar extending from the flange. The at least one mount assembly includes a mount base and a mount rest. The at least one mount assembly receives means for securing the at least one mount assembly to a vehicle. The vehicle may include a helicopter. The flange may outwardly protrude from the plate in a first direction, wherein the elongated member may outwardly protrude from the plate in a second direction, and wherein the first direction may be opposite to the second direction.

### BACKGROUND

1. Technical Field

The embodiments herein generally relate to a mounting system, and more particularly to a portable mounting system, which is capable of supporting an external equipment assembly.

2. Description of the Related Art

Commonly, for helicopters that do not have openings in the hull that permit internal mounting of sensing equipment, external mounts are bolted or otherwise semi-permanently attached to approved points or fixtures on the airframe. Under current United States Federal Aviation Administration (FAA) regulations, these installations constitute “major alterations” to the aircraft, and as such are subject to regulatory requirements that make them unsuitable for “walk up, attach and go” operations. For example, most approvals are specific only to single aircraft (not entire classes); also, licensed aviation mechanics typically must perform or sign off on all installations and removals.

Nevertheless, walk-up operations to any one of a particular class of aircraft are desirable when, for example, a helicopter is heavily scheduled and needs to be switched quickly between operational modes, such as between electronic sensing and passenger ferry operations; or when a mounted camera system must be quickly moved to a substitute aircraft if the primary aircraft suddenly goes down for maintenance.

Walk-up operations are possible when equipment is hand-held or when it can be supported with straps or by other temporary means that do not involve securing equipment externally to the airframe. Under FAA regulations, such arrangements can be classified by an operator/pilot as “minor alterations” if the installation does not degrade the airworthiness of the ship or the safety of in-flight operations (for example, precautions must be taken to prevent any hand-held items from dropping to the ground, i.e. with retaining straps tied to the aircraft).

However, because the helicopter hull, bubble or skids may interfere, hand-held sensors typically cannot be oriented for vertical views or 360-degree oblique views. For example, a straight ahead view (not degraded by shooting through the bubble) is especially desirable for helicopter videography, but is generally impossible to acquire using an interior camera. Wide-angle vertical photography without interference from the skids or struts is likewise generally impossible to acquire with internally positioned sensors. Therefore, it is desirable to have a “walk up, attach and go” quick mounting system that allows for the attachment and support of external equipment assemblies.

### SUMMARY

In view of the foregoing, an embodiment herein provides a portable mounting system configured to be detachably secured to a seat of a vehicle, the portable mounting system comprising a lateral bar comprising a first end and a second end; a first mount assembly comprising: a first mount attached to the first end of the lateral bar; and a first seatbelt channel attached to the first mount. The system further includes a second mount assembly spaced apart from the first mount assembly and comprising: a second mount attached to the first end of the lateral bar; and a second seatbelt channel attached to the second mount. The system further includes a plate attached to the second end of the lateral bar, wherein the plate comprises a point of contact for a load configured to extend out of the vehicle; and a first flange attached to the second end of the lateral bar, wherein the first flange connects the plate to the lateral bar. The seat may comprise a seatbelt, a seat back, and a seat base. The first mount assembly may comprise a first mount base configured to be in contact with the seat base, and the second mount assembly may comprise a second mount base configured to be in contact with the seat base. The first mount assembly may comprise a first mount rest configured to be in contact with the seat back, and the second mount assembly may comprise a second mount rest configured to be in contact with the seat back. The vehicle may comprise a helicopter. The system may further comprise a second flange detachably connected to the plate. The system may further comprise a bar extending from the second flange. The second flange may outwardly protrude from the plate in a first direction, wherein the lateral bar may outwardly protrude from the plate in a second direction, and wherein the first direction may be opposite to the second direction.

Another embodiment provides a mounting system comprising an elongated member comprising a first end and a second end; at least one mount assembly operatively connected to the first end of the elongated member, wherein the at least one mount assembly comprises a mount and a securing channel attached to the mount; a plate operatively connected to the second end of the elongated member; a flange attached to the plate; and a bar extending from the flange. The at least one mount assembly may comprise a mount base. The at least one mount assembly may comprise a mount rest. The at least one mount assembly may be configured to receive means for securing the at least one mount assembly to a vehicle. The vehicle may comprise a helicopter. The flange may outwardly protrude from the plate in a first direction, wherein the elongated member may outwardly protrude from the plate in a second direction, and wherein the first direction may be opposite to the second direction.

Another embodiment provides a system comprising an elongated member comprising a load end and a load counterbalance end; a plate positioned at the load end, wherein the plate comprises means for retaining a load extending from the plate; and at least one mount assembly positioned at the load counterbalance end, wherein the at least one mount assembly distributes a force to counterbalance a weight of the load, and wherein the at least one mount assembly is configured to receive means for securing the at least one mount assembly to a vehicle. The plate may be operatively connected to the elongated member, wherein the plate may comprise a flange and a bar extending from the flange, and wherein the bar may operatively connect to the load. The flange may outwardly protrude from the plate in a first direction, wherein the elongated member may outwardly protrude from the plate in a second direction, and wherein the first direction may be opposite to the second direction. The at least one mount assembly may comprise: a first mount assembly comprising a first mount and a first channel attached to the first mount; and a second mount assembly spaced apart from the first mount assembly, wherein the second mount assembly comprises a second mount and a second channel attached to the second mount. The means for securing the at least one mount assembly may be positioned over the first channel and the second channel. The vehicle may comprise a helicopter.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a right perspective view of a portable mounting system according to an embodiment herein;

FIG. 2 is a left perspective view of a portable mounting system according to an embodiment herein;

FIGS. 3A and 3B are side views of a first mount assembly and a second mount assembly of the portable mounting system according to an embodiment herein;

FIG. 4 illustrates a portable mounting system secured to the seat of a vehicle according to an embodiment herein;

FIG. 5 is a perspective view of a portable mounting system being retained by a seatbelt according to an embodiment herein;

FIG. 6 illustrates another perspective view of a portable mounting system being retained by a seatbelt according to an embodiment herein; and

FIG. 7 is a perspective view of a portable mounting system installed in a “walk up, attach and go” manner in a helicopter according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

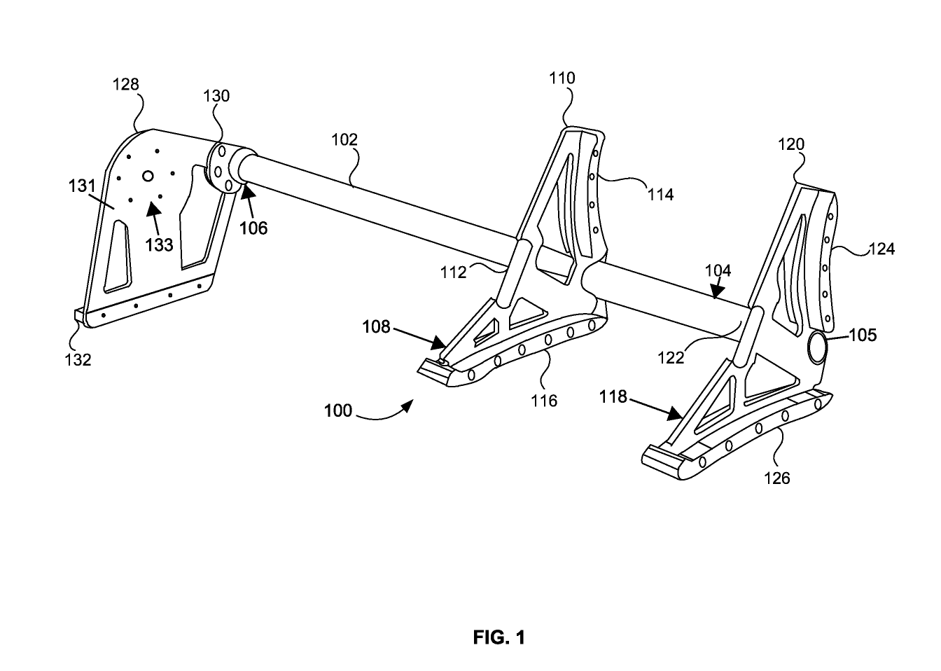

The embodiments herein provide a portable mounting system easily attachable to and detachable from the seat of a vehicle, such as a helicopter. Referring now to the drawings, and more particularly to FIGS. 1 through 7, where similar reference characters denote corresponding features consistently throughout the figures, there are shown preferred embodiments.

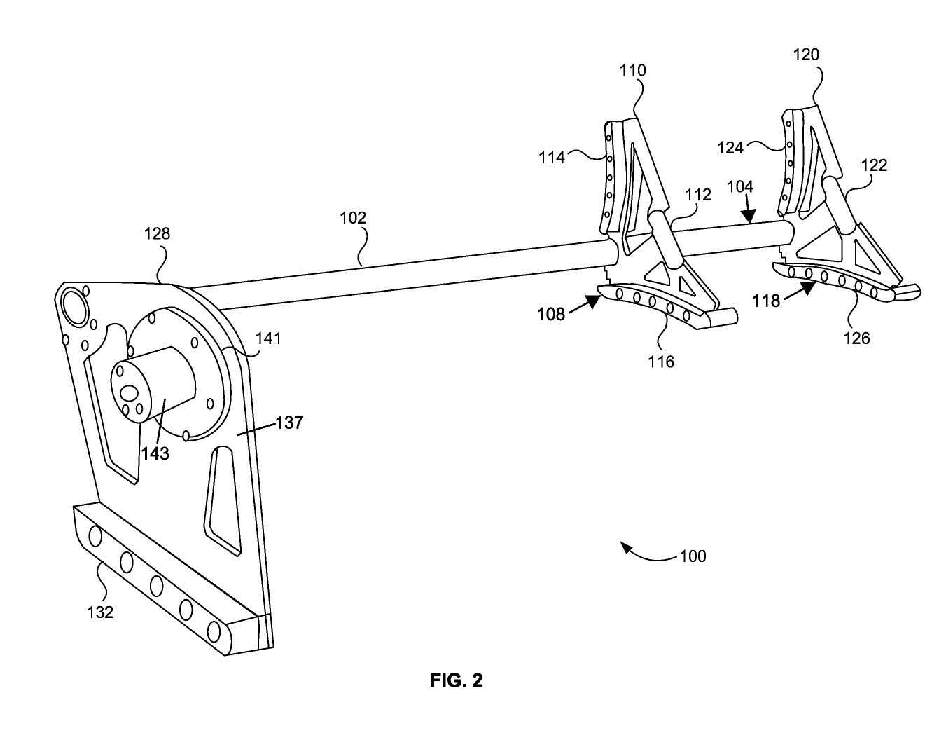

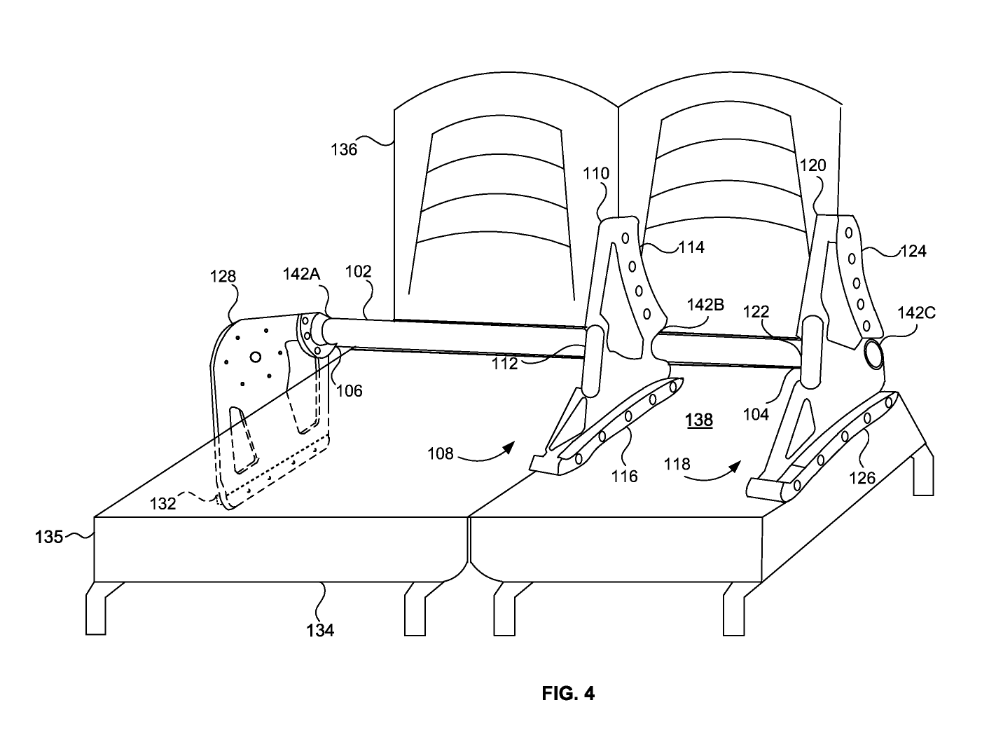

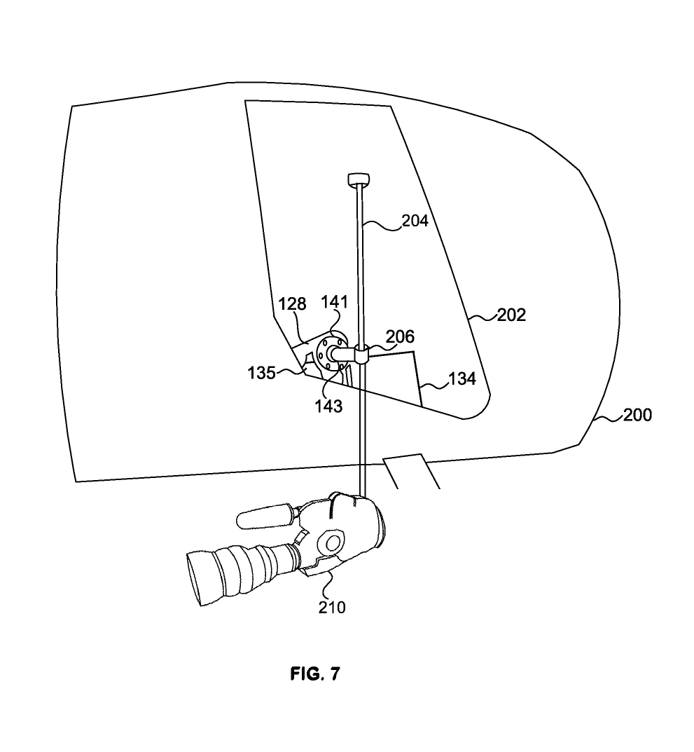

FIGS. 1 and 2 are right and left perspective views, respectively, of a portable mounting system 100 that is configured to be secured to a seat of a vehicle according to an embodiment herein. The portable mounting system 100 includes a lateral bar 102 with a first end 104 and a second end 106, a first mount assembly 108, a second mount assembly 118, and a bolt plate 128. In one embodiment, the lateral bar 102 is configured to be positioned horizontally on the seat (e.g., backseat) 134 (as shown in FIG. 4) of a vehicle, such as a helicopter 200 (shown in FIG. 7). In one example embodiment, the first mount assembly 108 and the second mount 118 assembly are triangular in shape (although other shapes and configurations are possible) so as to substantially contour the respective configurations of the seat 134. In one embodiment, the second mounting assembly 118 could be detachably connected to the first end 104 of the lateral bar 102 and the bolt plate 128 could be detachably connected to the second end 106 of the lateral bar 102. Additionally, while not shown in the drawings, the lateral bar 102 may be configured in multiple sections that are detachably connected together. For example, the lateral bar 102 may be configured as a substantially hollow tube that can be disassembled by removing at least one stainless steel pin (not shown) used for the connection. The various detachable connections described above may be embodied using attachment means such as a bolt, pin, threaded configuration, etc. or any other suitable attachment mechanism. Moreover, the detachable connections described above permit ease in attachment/detachment, transporting, and storage of the system 100. The second end 106 of the lateral bar 102 is fastened to the bolt plate 128 through a bolt flange 130. The bolt plate 128 also includes a plate base 132.

Again with reference to the lateral bar 102, the connection point on the lateral bar 102 (e.g., in an embodiment where the lateral bar 102 is configured as multiple pieces connected together) is between the first mount assembly 108 and the bolt plate 128. In an embodiment, the portion of the lateral bar 102 between the bolt plate 128 and the first mount assembly 108 (for example, a first portion) is configured to be a detachable from the portion of the lateral bar 102 between the first mount assembly 108 and the second mount assembly 118 (for example, a second portion), such that the first portion slides into the second portion together like tent poles, or may be attached using a matingly threaded configuration, etc. In an embodiment, the lateral bar 102 may be tungsten inert gas (TIG) welded to the first and second mount assemblies 108, 118.

In one embodiment, the lateral bar 102 comprises aluminum or some other lightweight, yet high-strength metal or material. The first mount assembly 108 includes a first mount 110, a first seatbelt channel 112, a first mount rest 114, and a first mount base 116. The first mount rest 114 is dimensioned and configured to contour the seat back 136 of the seat 134 (shown in FIG. 4) and the first mount base 116 is dimensioned and configured to contour the top of the seat base 138 of the seat 134 (shown in FIG. 4). Alternatively, the first mount 110 fits in between the adjacent seats 134 in the rear of a vehicle, such as a helicopter 200 (shown in FIG. 7), to allow for a further snug fit to the seat 134. The first mount 110 is attached to the lateral bar 102 at the first end 104 and at a predetermined distance from the edge 105 of the lateral bar 102, and is positioned substantially vertically on the lateral bar 102. The predetermined distance may include, for example the width of the seat 134. In one embodiment, the first mount 110 comprises aluminum or some other lightweight, yet high-strength metal or material. The first mount 110 is configured to be placed on the seat 134 and held in place using a seatbelt 140 to fasten the first mount assembly to the seat 134. The portable mounting system 100 enables securing a load (e.g., a pole 204 holding a camera 210, etc. that is connected to the bolt plate 128, as shown in FIG. 7) to the seat 134 by counterbalancing the weight of the load with the distributed weight of the system 100 held in place by the seatbelt 140. Due to the lightweight configuration of the system 100, the system 100 may be easily attached/detached from the seat 134 of the vehicle (e.g., helicopter 200 (as shown in FIG. 7)) to allow for a “walk up, attach and go” installation.

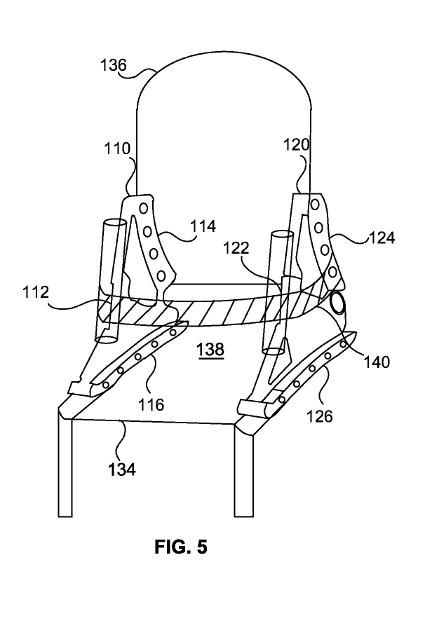

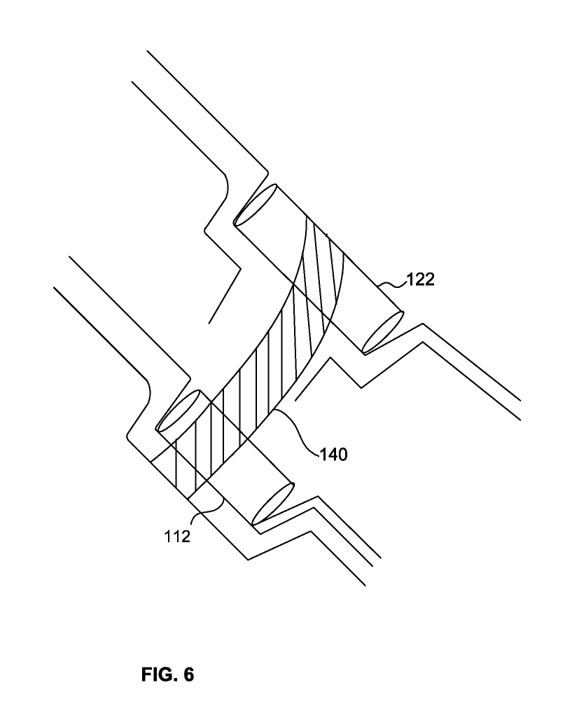

A first seatbelt channel 112 is attached to the first mount 110 along an edge of the first mount 110. In one embodiment, the first seatbelt channel 112 provides a path for securely retaining the seatbelt 140 (shown in FIGS. 5 and 6) to the first mount assembly 108 by allowing the seatbelt 140 to be pushed down securely and against the first mount assembly 108. The first mount rest 114 is attached to a top edge of the first mount 110. The first mount rest 114 may be held against the seat back 136 (shown in FIGS. 4 and 5) upon securing the seatbelt 140 in place. The first mount base 116 is attached to the first mount 110. The first mount base 116 may be held against the seat base 138 (shown in FIGS. 4 and 5) upon securing the seatbelt 140 in place.

Similarly, the second mount assembly 118 includes a second mount 120, a second seatbelt channel 122, a second mount rest 124, and a second mount base 126. The second mount rest 124 is dimensioned and configured to contour the seat back 136 of the seat 134 (shown in FIG. 4) and the second mount base 126 is dimensioned and configured to contour the top of the seat base 138 of the seat 134 (shown in FIG. 4). Alternatively, the second mount 120 fits in between the adjacent seats 134 in the rear of a vehicle, such as a helicopter 200 (shown in FIG. 7), to allow for a further snug fit to the seat 134. The second mount 120 is attached to the lateral bar 102 at the first end 104 and is positioned substantially vertically on the lateral bar 102. In one embodiment, the second mount 120 comprises aluminum or some other lightweight, yet high-strength metal or material. The second mount 120 is configured to be placed on the seat 134 and held in place using a seatbelt 140 to fasten the second mount assembly to the seat 134. The portable mounting system 100 enables securing a load (e.g., a pole 204 holding a camera 210, etc. that is connected to the bolt plate 128, as shown in FIG. 7) to the seat 134 by counterbalancing the weight of the load with the distributed weight of the system 100 held in place by the seatbelt 140. In one embodiment, the lateral bar 102 is run along the far back edge of the seat 134 (shown in FIG. 4), which prevents the lateral bar 102 from interfering with a passenger/crew member who then can serve as an attendant for the system 100 or perform some other function/duty required. Due to the lightweight configuration of the system 100, the system 100 may be easily attached/detached from the seat 134 of the vehicle (e.g., helicopter 200, as shown in FIG. 7) to allow for a “walk up, attach and go” installation.

A second seatbelt channel 122 is attached to the second mount 120 along an edge of the second mount 120. In one embodiment, the second seatbelt channel 122 provides a path for securely retaining the seatbelt 140 (shown in FIGS. 5 and 6) to the second mount assembly 118 by allowing the seatbelt 140 to be pushed down securely and against the second mount assembly 118. The second mount rest 124 is attached to a top edge of the second mount 120. The second mount rest 124 may be held against the seat back 136 (shown in FIGS. 4 and 5) upon securing the seatbelt 140 in place. The second mount base 126 is attached to the second mount 120. The second mount base 126 may be held against the seat base 138 (shown in FIGS. 4 and 5) upon securing the seatbelt 140 in place.

In one embodiment, the bolt plate 128 includes a bolt flange 130. The bolt flange 130 is configured to secure the second end 106 of the lateral bar 102 to the bolt plate 128. The plate base 132 is configured to be facing away from the side 135 of the seat 134 (shown in FIG. 4). The plate base 132 further helps to distribute the weight of the load (e.g., pole 204 holding a camera 210, etc. attached to the bolt plate 128, as shown in FIG. 7) and helps prevent vertical movement of the load (e.g., slippage of the load, etc.). Specifically, the plate base 132 may be attached (e.g., bolted, etc.) to the bottom of the bolt plate 128 to help support the weight of the load primarily in a vertical direction. In an embodiment, the bolt plate 128 and the bolt flange 130 may comprise aluminum or other lightweight, yet high- strength metal or material. Upon installation into a vehicle 200, as shown in FIG. 7, (e.g., “walk up, attach and go” installation), the portable mounting system 100 can be strapped to the seat 134 of the vehicle 200 and the bolt plate 128 is positioned adjacent to a door opening (door removed) (e.g., window 202) next to the back seat 134 to allow a pole 204 to outwardly protrude and extend from the open door ready to accept a wide variety of loads (e.g., a camera 210, etc.). The vehicle 200 may be a wagon, a motor vehicle (e.g., cars, trucks, buses, train), a watercraft (e.g., ships, boats), or an airborne vehicle (e.g., helicopter, drone, spacecraft, aerostat, or other aircraft). In one embodiment, the load may be a camera or other type of electronic sensor with associated equipment, a consignment, a shipment, and/or cargo, and the like. In an embodiment, the lateral bar 102 is positioned to rest and run along the back 136 of the interceding seat 134, which enables an attendant to sit next to the load (e.g., pole 204 holding the camera 210) and perform tasks in-flight as needed (i.e., lower the load beneath the skids after take-off for vertical or 360-degree oblique views, etc.).

In an embodiment, the bolt plate 128 includes a donut flange 141 or any other suitably configured flange, coupling, or connector, etc. The donut flange 141 may be connected to the bolt plate 128 through, for example, bolts, screws, pins, etc. In an embodiment, the bolt plate 128 is the mounting/contact point between the portable mounting system 100 and the load (e.g., pole 204 holding a video camera 210, etc. attached to the base plate 128, as shown in FIG. 7), and the connection is made through a bar or other support member 143 extending from the donut flange 141. For example, with reference to FIG. 7, a pole 204 holding a camera 210 may be detachably connected to the bolt plate 128 through the bar 143 of the donut flange 141 to allow for easy attachment/detachment of the camera 210 to the system 100, such that the pole 204 extends below the hull of the helicopter 200 to allow the camera 210 to capture images/video in vertical or an unobstructed 360-degree oblique orientation. To further allow for the proper weight distribution and load balance, the lateral bar 102 attaches to the upper portion of the bolt plate 128 and the generally lower portions of the first mount assembly 108 and second mount assembly 118 such that the bolt plate 128 is substantially positioned below the lateral bar 102. In one embodiment, the donut flange 141 is positioned on a side 137 of the bolt plate 128 opposite to the side 131 where the bolt flange 130 is located (e.g., opposite to the side 131 where the lateral bar 102 connects to the bolt plate 128). In another embodiment, the donut flange 141 is positioned on the same side 131 of the bolt plate 128 where the bolt flange 130 is located. In still another embodiment, there may be multiple donut flanges 141 positioned on both sides 131, 137 of the bolt plate 128. In yet another embodiment, the donut flange 141 may be a single flange that extends to both sides 131, 137 of the bolt plate 128. FIG. 1 illustrates the holes/connections 133 for attaching the donut flange 141 to the same side 131 of the bolt plate 128 as the bolt flange 130. These holes/connections 133 are the same holes/connections used to secure the donut flange 141 on the other side 137 (shown in FIG. 2) of the bolt plate 128 also. Again, the donut flange 141 may be configured as any type of flange, coupling, or connector, etc. to permit further connection to and support of a load that extends outside of the vehicle (e.g., helicopter 200).

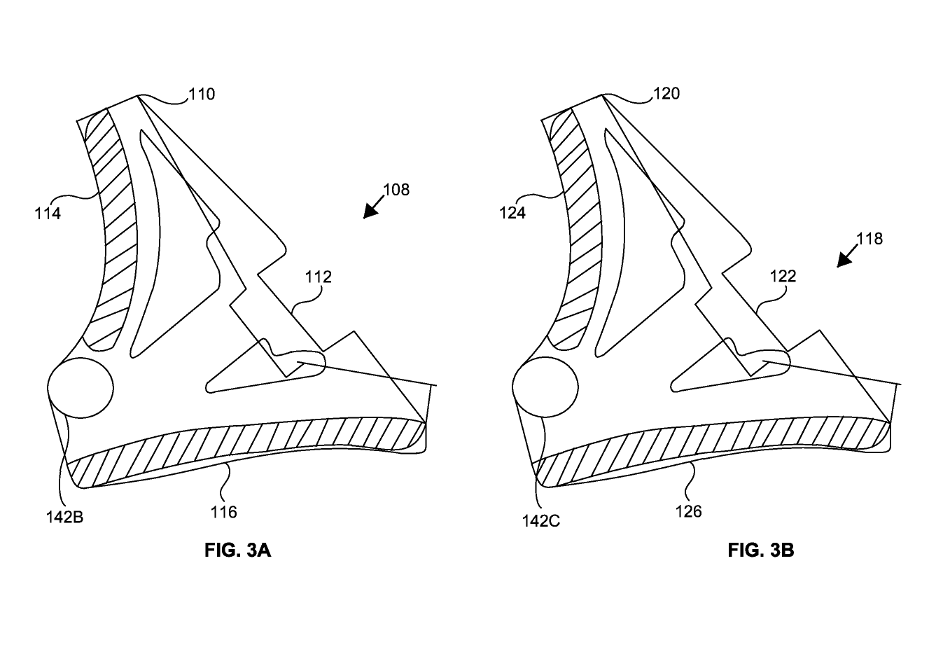

FIGS. 3A and 3B, with reference to FIGS. 1 and 2, are side views of the first mount assembly 108 and second mount assembly 118 of the portable mounting system 100 according to an embodiment herein. The first mount 110 of the first mount assembly 108 and the second mount 120 of the second mount assembly 118 each comprise holes 142B, 142C, respectively, to accommodate the lateral bar 102. In one embodiment, holes 142B, 142C are aligned substantially parallel with each other so that the lateral bar 102 passes through the holes 142B, 142C. Accordingly, the lateral bar 102 is tightly positioned through holes 142B, 142C to affix the lateral bar 102 to the first mount assembly 108 and second mount assembly 118. The bolt flange 130 also includes a similarly configured hole 142A (as indicated in FIG. 4) to accommodate the lateral bar 102 and allow the lateral bar 102 to connect to the bolt flange 130, and thus to connect to the bolt plate 128. FIGS. 3A and 3B further illustrate the first and second seatbelt channels 112, 122 configured in the first and second mounts 110, 120, respectively, which provide a securing channel for the seatbelt 140 to rest in (shown in FIGS. 5 and 6) upon installation.

FIG. 4, with reference to FIGS. 1 through 3, illustrates the portable mounting system 100 fitted onto the seat 134 of a vehicle (such as a helicopter 200, as shown in FIG. 7) according to an embodiment herein. FIG. 5, with reference to FIGS. 1 through 4, illustrates a perspective view of the portable mounting system 100 being secured by seatbelt 140 at a fastened position for holding the first mount assembly 108 and the second mount assembly 118 in an attached/secured position according to an embodiment herein. In one embodiment, the portable mounting system 100 is positioned on a rear seat (such as seat 134) of the vehicle 200 (shown in FIG. 7) and is secured and held in place using the releasable seatbelt 140 as opposed to requiring a permanent attachment fixture or human operator holding the mounting system 100 in order to provide a counterbalance to the weight of the load (e.g., camera 210 of FIG. 7) attached to the donut flange 141 of the bolt plate 128. The portable mounting system 100 is placed on the rear seat 134 of the vehicle 200 (shown in FIG. 7) and a rear seatbelt 140 is extended over the system 100 such that the seatbelt 140 rests in the first seatbelt channel 112 and the second seatbelt channel 122. Accordingly, the first seatbelt channel 112 and the second seatbelt channel 122 are oriented such that the seatbelt 140 is fastened across the first mount assembly 108 and the second mount assembly 118 to secure the mounting system 100 firmly against the seat 134.

The first seatbelt channel 112 and the second seatbelt channel 122 may be comprised of solid rounded pieces of acrylonitrile butadiene styrene (ABS) material with an angled slot (not shown) cut within them such that they can be pressed onto the first and second seatbelt channels 112, 122, respectively. The rounded ABS material gives the seatbelt 140 a good point of contact to apply pressure and fasten down and against the portable mounting system 100 while protecting the seatbelt 140 against abrasions that could exist if the seatbelt 140 made direct contact with the aluminum components of the first and second mounts 110, 120, respectively. The seatbelt channels 112, 122 may be configured to accommodate any size ABS material including material that is longer than the seatbelt channels 112, 122 to permit seatbelt attachment for helicopters having different seatbelt positions.

In one embodiment, the first mount rest 114, the second mount rest 124, the first mount base 116, and the second mount base 126 are attached (e.g., bolted) to the first mount 110 and the second mount 120. In an embodiment, the first mount 110 and the second mount 120 may be wrapped in lambskin or other soft material and/or fabric attached to ABS material by Velcro® tape to protect the seats 134 from being torn by the sharp metal components of the first and second mounts 110, 120. In an embodiment, the first mount rest 114, the second mount rest 124, the first mount base 116, and the second mount base 126 are dimensioned and configured to be sufficiently wide to distribute the force applied when the seatbelt 140 (shown in FIG. 5) is fastened. In an embodiment, the dimensions and configurations of the bolt plate 128 as well as the first mount 110 and the second mount 120 may be selected to reduce the overall weight of the system 100.

FIG. 6, with reference to FIGS. 1 through 5, illustrates a seatbelt 140 that extends over the first seatbelt channel 112 of first mount assembly 108 and the second seatbelt channel 122 of the second mount assembly 118 to fasten and securely retain the portable mounting system 100 to the seat 134 of the vehicle (e.g., helicopter 200, as shown in FIG. 7) according to an embodiment herein. FIG. 7, with reference to FIGS. 1 through 6, is a perspective view of the portable mounting system 100 positioned on a seat 134 of a vehicle (e.g., a helicopter, etc.) 200. A support pole 204 is attached to the bar 143 extending from the donut flange 141 of the bolt plate 128 of the portable mounting system 100 such that the bolt plate 128 sits adjacent to the door/window 202 of the 200 with the support pole 204 extending out of the door/window 202 in a vertical direction. As depicted in FIG. 7, in one embodiment, the support pole 204 is attached to the bar 143 with a coupling 206. The support pole 204 is configured to hold a load (e.g., a camera, etc.) 210 to capture unobstructed views below the helicopter 200 in a 360-dgree orientation.

The portable mounting system 100 does not require any material between an operator and the seat 134. The system 100 can be mounted in such a way that the right door/window 202 of the helicopter 200 can be removed away from the intake side of the tail rotor, for improved safety. Alternatively, the configuration of the portable mounting system 100 may be switched such that the lateral bar 102 extends from the opposite side of the bolt plate 128 with the first and second mount assemblies 108, 118 positioned to the other side of the bolt plate 128 to permit the system 100 to be used on the left side door of the helicopter 200, and the left side door/window of the helicopter 200 can be removed accordingly.

The portable mounting system 100 provided by the embodiments herein is mounted independent of the vehicle operator and/or passengers and is not affected by the weight of the operator and/or passengers and allows for a much wider range of image/video capturing. The system 100 can be mounted on the rear seat 134 of the vehicle 200 and is configured to contour with the seat 134 to permit a passenger to also comfortably sit on the seat 134 as well without interfering with the structural integrity or functionality of the system 100, and to further permit the passenger and/or operator to access the load (e.g., camera) 210 attached to the bolt plate 128, if necessary before, after, or even during movement of the vehicle 200 (e.g., flight of the helicopter).

Additionally, in accordance with the embodiments herein, an attendant may be strategically positioned on the seat 134 without interfering with the structural integrity or functionality of the system 100 to be able to lower the system 100 after take-off and raise the system 100 before landing, as well as make adjustments to the equipment (e.g., camera 210 or other parts of the system 100, etc.) in-flight. Moreover, the length of the lateral bar 102 is dimensioned and configured (e.g., width of the seat 134 and/or internal width of the vehicle 200) to provide enhanced leverage, thereby allowing a heavier load to be attached to the bar 143 and/or support pole 204. The portable mounting system 100 may be installed quickly and is easily transportable since it is not permanently attached to the vehicle 200 (e.g., helicopter), which allows it to be considered a “walk up, attach and go” installation.

As shown in FIGS. 1 through 7, the embodiments herein provide a portable mounting system 100 configured to be detachably secured to a seat 134 of a vehicle (e.g., a helicopter) 200. The portable mounting system 100 comprises an elongated member (e.g., lateral bar 102) comprising a first end (e.g., load counterbalance end) 104 and a second end (e.g., load end) 106; at least one mount assembly 108, 118 such as for example, a first mount assembly 108 and a second mount assembly 118. The first mount assembly comprises a first mount 110 attached to the first end 104 of the lateral bar 102; and a first channel (e.g., securing channel or seatbelt channel) 112 attached to the first mount 104. The second mount assembly 118 is spaced apart from the first mount assembly 110 and comprises a second mount 120 attached to the first end 104 of the lateral bar 102; and a second channel (e.g., securing channel or seatbelt channel) 122 attached to the second mount 120. The system 100 further includes a plate (e.g., bolt plate) 128 attached to the second end 106 of the lateral bar 102, wherein the plate 128 comprises a point of contact for a load (e.g., support pole 204 carrying a camera 210) configured to extend out of the vehicle 200; and a first flange (e.g., bolt flange) 130 attached to the second end 106 of the lateral bar 102, wherein the first flange 130 connects the plate 128 to the lateral bar 102.

The seat 134 comprises a seatbelt 140, a seat back 136, and a seat base 138. The first and second mount assemblies 108, 118 are configured with the respective seatbelt channels 112, 122 to receive means for securing (e.g., the seatbelt 140) the first and second mount assemblies 108, 118 to the vehicle 200 such that the means for securing (e.g., the seatbelt 140) is positioned over the first and second seatbelt channels 112, 122. The first mount assembly 108 comprises a first mount base 116 configured to be in contact with the seat base 138, and the second mount assembly 118 comprises a second mount base 126 configured to be in contact with the seat base 138. The first mount assembly 108 comprises a first mount rest 114 configured to be in contact with the seat back 136, and the second mount assembly 118 comprises a second mount rest 124 configured to be in contact with the seat back 136. The system 100 further comprises a second flange (e.g., donut flange which retains the load extending from the plate 128) 141 detachably connected to the plate 128. The system 100 further comprises a bar 143 extending from the second flange 141. The second flange 141 may outwardly protrude from the plate 128 in a first direction (e.g. from side 137 of the plate 128), wherein the lateral bar 102 may outwardly protrude from the plate 128 in a second direction (e.g., from side 131 of the plate 128), and wherein the first direction may be opposite to the second direction (e.g., side 137 is opposite to side 131 of the plate 128). The mount assemblies 108, 118 help to distribute a force to counterbalance the weight of the load (e.g., camera 210).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A portable mounting system configured to be detachably secured to a seat of a vehicle, said portable mounting system comprising:
a lateral bar comprising a first end and a second end;
a first mount assembly comprising:
a first mount attached to said first end of said lateral bar; and
a first seatbelt channel attached to said first mount;
a second mount assembly spaced apart from said first mount assembly and comprising:
a second mount attached to said first end of said lateral bar; and
a second seatbelt channel attached to said second mount;
a plate attached to said second end of said lateral bar, wherein said plate comprises a point of contact for a load configured to extend out of said vehicle; and
a first flange attached to said second end of said lateral bar, wherein said first flange connects said plate to said lateral bar.

2. The system of claim 1, wherein said seat comprises a seatbelt, a seat back, and a seat base.

3. The system of claim 2, wherein said first mount assembly comprises a first mount base configured to be in contact with said seat base, and wherein said second mount assembly comprises a second mount base configured to be in contact with said seat base.

4. The system of claim 2, wherein said first mount assembly comprises a first mount rest configured to be in contact with said seat back, and wherein said second mount assembly comprises a second mount rest configured to be in contact with said seat back.

5. The system of claim 1, wherein said vehicle comprises a helicopter.

6. The system of claim 1, further comprising a second flange detachably connected to said plate.

7. The system of claim 6, further comprising a bar extending from said second flange.

8. The system of claim 6, wherein said second flange outwardly protrudes from said plate in a first direction, wherein said lateral bar outwardly protrudes from said plate in a second direction, and wherein said first direction is opposite to said second direction.

9. A mounting system comprising:
an elongated member comprising a first end and a second end;
at least one mount assembly operatively connected to said first end of said elongated member, wherein said at least one mount assembly comprises a mount and a securing channel attached to said mount;
a plate operatively connected to said second end of said elongated member;
a flange attached to said plate; and
a bar extending from said flange.

10. The system of claim 9, wherein said at least one mount assembly comprises a mount base.

11. The system of claim 9, wherein said at least one mount assembly comprises a mount rest.

12. The system of claim 9, wherein said at least one mount assembly is configured to receive means for securing said at least one mount assembly to a vehicle.

13. The system of claim 12, wherein said vehicle comprises a helicopter.

14. The system of claim 9, wherein said flange outwardly protrudes from said plate in a first direction, wherein said elongated member outwardly protrudes from said plate in a second direction, and wherein said first direction is opposite to said second direction.

15. A system comprising:
an elongated member comprising a load end and a load counterbalance end;
a plate positioned at said load end, wherein said plate comprises means for retaining a load extending from said plate; and
at least one mount assembly positioned at said load counterbalance end, wherein said at least one mount assembly distributes a force to counterbalance a weight of said load, and wherein said at least one mount assembly is configured to receive means for securing said at least one mount assembly to a vehicle.

16. The system of claim 15, wherein said plate is operatively connected to said elongated member, wherein said plate comprises a flange and a bar extending from said flange, and wherein said bar operatively connects to said load.

17. The system of claim 16, wherein said flange outwardly protrudes from said plate in a first direction, wherein said elongated member outwardly protrudes from said plate in a second direction, and wherein said first direction is opposite to said second direction.

18. The system of claim 15, wherein said at least one mount assembly comprises:
a first mount assembly comprising a first mount and a first channel attached to said first mount; and
a second mount assembly spaced apart from said first mount assembly, wherein said second mount assembly comprises a second mount and a second channel attached to said second mount.

19. The system of claim 18, wherein said means for securing said at least one mount assembly is positioned over said first channel and said second channel.

20. The system of claim 15, wherein said vehicle comprises a helicopter.
